(19) United States
(12) Patent Application Publication
(10) Pub. No.: US 2014/0033972 A1
(43) Pub. Date: Feb. 6, 2014

(54) Seed Flow Rate and Dispersion Pattern Regulator

(71) Applicants: Dominic Eugene Meyer, Sabetha, KS (US); Paul Kaeb, Sabetha, KS (US); Todd William Kaeb, Cissna Park, IL (US); Jason Paul Kaeb, Sabetha, KS (US)

(72) Inventors: Dominic Eugene Meyer, Sabetha, KS (US); Paul Kaeb, Sabetha, KS (US); Todd William Kaeb, Cissna Park, IL (US); Jason Paul Kaeb, Sabetha, KS (US)

(73) Assignee: KSi Conveyors, Inc., Cissna Park, IL (US)

(21) Appl. No.: 13/958,521

(22) Filed: Aug. 2, 2013

Related U.S. Application Data
(60) Provisional application No. 61/678,679, filed on Aug. 2, 2012.

(51) Int. Cl. A01C 1/06

(52) U.S. Cl. CPC A01C 1/06
USPC 118/303; 118/500

(57) ABSTRACT

A variable regulator for controlling the flow rate and the dispersion pattern of the seed flow through a seed treatment applicator system. The regulator uses two or more shutters to define a plurality of vertical through-passages. The number, size, shape, and pattern of these vertical through-passages determine the flow rate and dispersion pattern. The regulator disclosed produces a flow of seed that is evenly distributed about the central vertical axis under high and low flow rates and exposes a greater amount of seed surface area to the airborne treatment fluid.

### CROSS-REFERENCE TO RELATED APPLICATIONS

This is a non-provisional application related to provisional application 61/678,679 titled Bulk Seed Treatment System.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not Applicable

### FIELD

The present invention is in the technical field of regulating the flow rate and dispersion pattern of a particulate matter.

### BACKGROUND

Seeds planted for agricultural and other purposes are often treated with an agrichemical such as insecticides, inoculants, micronutrients or other beneficial compositions prior to planting. Treatment may accomplish various purposes including inhibiting the growth of insects, bacteria, molds, fungus, and parasites that are destructive to the seed and plant growth. Seed treatments are commonly applied by spraying a liquid composition to the surface of seed as the seed falls through a treatment chamber. Direct application of the seed treatment fluid to the seed before planting requires a smaller quantity of seed treatment composition than the traditional field application of treatment fluids.

In the treatment chamber, airborne droplets of treatment fluid are applied to the seed surface. Direct application of the seed treatment fluid to the seed before planting requires a smaller quantity of seed treatment composition than the traditional field application of treatment fluids. An ideal treatment system applies treatment fluid uniformly across the surface of the seed, minimizes treatment fluid waste, and is easily maintained.

Treatment system components are commonly stacked vertically, where the seed falls under the force of gravity through the various components. A metered quantity of seed flows into a treatment chamber. A cone-shaped housing then disperses the seed flow into an annular veil.

A spinning atomizer is commonly used to distribute airborne droplets of treatment fluid from the center of the treatment system. These airborne droplets make contact with the treatment face—which is the interior perimeter of the annular veil of seed in existing seed treatment systems. Treatment systems commonly rely on a rotating mixing drum to coat the entire seed with treatment fluid.

### SUMMARY OF THE INVENTION

In treating seeds, the problems of coating only a small portion of the metered seed flow through the treatment chamber can be solved by incorporating a seed flow regulator that simultaneously adjusts the rate and dispersion pattern of seed flow. The regulator uses two or more shutters to control the volume and shape of the seed flow as the seed flow passes the atomizer. The shutters can be positioned in a closed orientation where the shutters are aligned to prevent any seed flow through the treatment chamber. The shutters can be rotated—horizontally—to an open orientation. In the open orientation, the shutters are positioned to form vertical through-passages that allow the seed to flow into the treatment chamber.

In one example, the shutters have two or more apertures—or slots—that extend from the top of the shutter to the bottom. The pattern of apertures are arranged to align with certain apertures in other shutters to form the vertical through-passages. For example, the regulator could have two shutters: a top shutter and a bottom shutter. Both shutters are disk shaped. Both shutters have slots that extend vertically through the disk. An adjustable shaft is connected to the regulator to control the relative orientation of the two shutters. The pattern of the slots allows the regulator to completely prevent seed flow in one orientation. When the adjustable shaft changes the relative orientation of the two slotted disk shutters, at least a portion of the slots overlap. This overlap defines a vertical through-passage and allows seed to enter the treatment chamber. The size and shape of the vertical through-passage determines the shape of the seed flow through the treatment chamber.

Alternatively, the regulator can utilize solid shutters. The solid shutters can also pivot horizontally, into and out of the seed flow path. The solid shutters can control the flow rate and dispersion pattern by using shutters where one end is larger than a smaller end. This larger end extends into the seed flow path to prohibit the seed flow. The other end of the solid shutter is smaller. This smaller end extends into the seed flow path. In this embodiment, the axis of rotation is between the smaller end and the larger end. Depending on the degree of rotation of the individual shutters, the regulator controls the seed flow rate and dispersion pattern.

The atomizer—located below the regulator—delivers an airborne fluid treatment to coat the exposed surface area of the seed as it descends through the treatment chamber. The shape of the dispersion pattern determines the amount of surface area of the seed flow that makes contact with the treatment fluid. This dispersion pattern—or treatment face—is defined by the vertical through-passages in the regulator.

The number, size, shape, and pattern of the vertical through-passages define the flow rate and dispersion pattern of the seed—or other particulate matter. The number, size, shape, and pattern can be optimized depending on the flow rate and dispersion pattern required in the specific application. For seed treatment applicators, a rotating disk atomizer applies the fluid seed treatment as the seed descends through the treatment chamber. The treatment fluid is dispersed through the air in an even circular pattern. In existing seed treatment applicators the seed flows through the treatment chamber as an annular veil. The airborne treatment fluid can only make contact with the interior perimeter of the annular veil of seed. Our regulator increases the surface area exposed to the airborne fluid treatment relative to the amount of particulate material that flows through the treatment chamber.

Another advantage of our regulator is the ability to control the flow rate and dispersion pattern in a single mechanism. Current seed treatment applicators have separate mechanisms for regulating seed flow and dispersion pattern. U.S. Pat. No. 5,891,246 to Lund, the disclosure of which is hereby incorporated by reference, describes a conical, rotating seed dispersing member that disperses an even curtain of seed and a rotating fluid dispensing member for dispensing seed treatment composition. U.S. patent application Ser. No. 12/848,412 by Reineccius, the disclosure of which is hereby incorporated by reference, describes an apparatus and method for introducing seed into the treatment chamber through the use of a volumetric seed wheel. A fixed dispersion cone then uniformly disperses the seed.

These existing seed treatment applicators have limited control of seed distribution in the treatment chamber. We have developed a regulator capable of adjusting the dispersion pattern based on a variable flow rate—thereby optimizing the surface area exposed to treatment fluids under high and low flow rates.

Even distribution and variable flow are important in transferring granular material such as seed from a storage location to another processing point. For use in a seed treatment system, our regulator allows for a controlled and uniform flow of seed that increases surface area exposed to fluid treatment solutions applied by any combination of spray valves or rotating disk atomizers. By varying the number, size, shape, and pattern of the vertical through-passages, the regulator can maximize the amount of surface exposed to the airborne treatment fluid relative to the volume of seed flow.

The seed is disbursed in a pattern of flow such that a greater “treatment face” or seed surface area is exposed to the airborne treatment fluid. The number, size, shape, and pattern of the vertical through-passages are defined by the configuration of the shutters as well as the relative orientation of the shutters.

### BRIEF DESCRIPTION OF THE DRAWINGS

FIG. 1 is a top view of a slotted disk shutter regulator of the present invention;

FIG. 2 is a bottom view of a slotted disk shutter regulator of the present invention;

FIG. 3 is an exploded view of the components of the slotted disk shutter regulator of FIGS. 1 and 2;

FIG. 4 is a top view of the closed orientation of a solid shutter regulator of the present invention;

FIG. 5 is a top view of a partially open orientation of a solid shutter regulator of the present invention;

FIG. 6 is a top view of a open orientation of a solid shutter regulator of the present invention;

FIG. 7 is an exploded view of the components of the solid shutter regulator of FIGS. 4-6.

### DETAILED DESCRIPTION

Effective seed treatment requires an effective amount of treatment fluid is applied to each individual seed. Existing seed treatment applicators use a single, central atomizer to apply an excessive amount of seed treatment to a small portion of the total quantity of seed. The seed then enters a mixing drum in an attempt to evenly distribute the treatment fluid so that an effective amount is spread across each individual seed.

The present inventors recognized that the seed treatment process would be more effective and faster if the seed treatment applicator could apply an effective quantity of treatment fluid directly to a larger portion of seed. The inventors discovered that by designing a variable regulator, that they could regulate the flow rate and the dispersion pattern of the seed flow. The regulator produces a flow of seed that is evenly distributed about the central vertical axis under high and low flow rates.

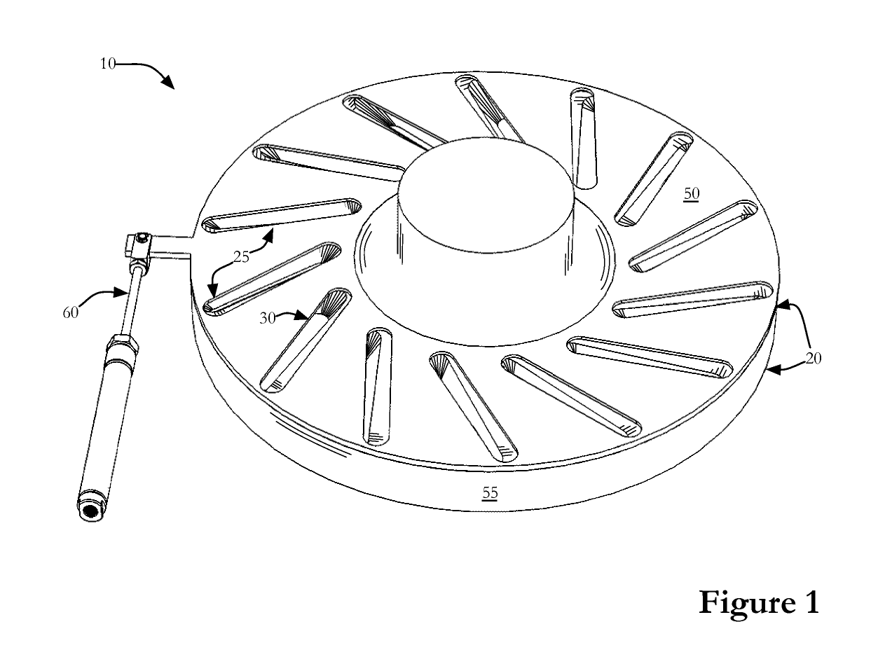

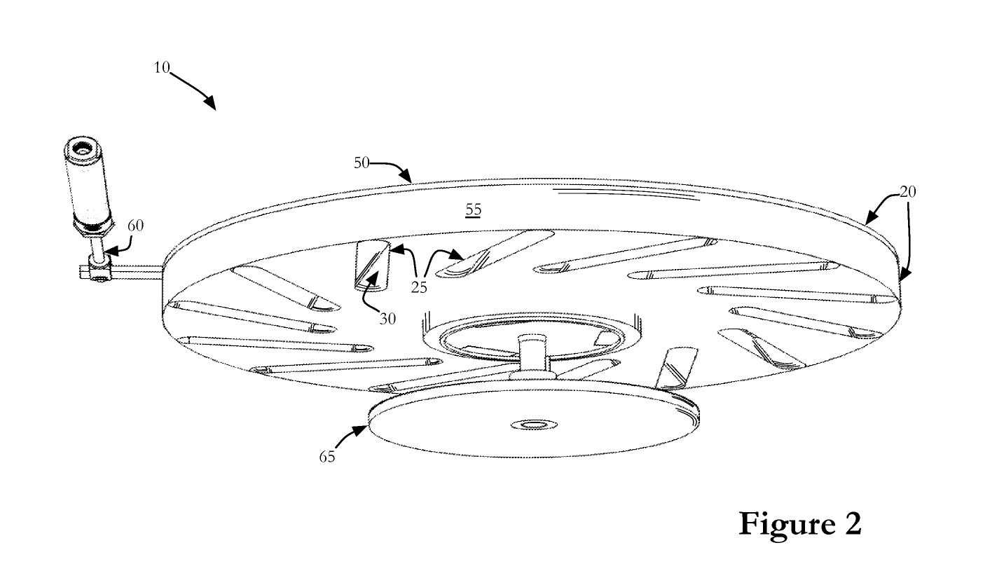

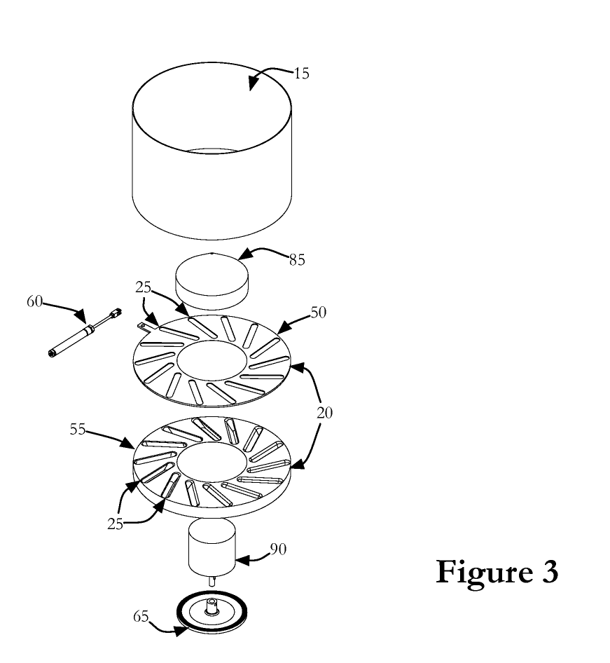

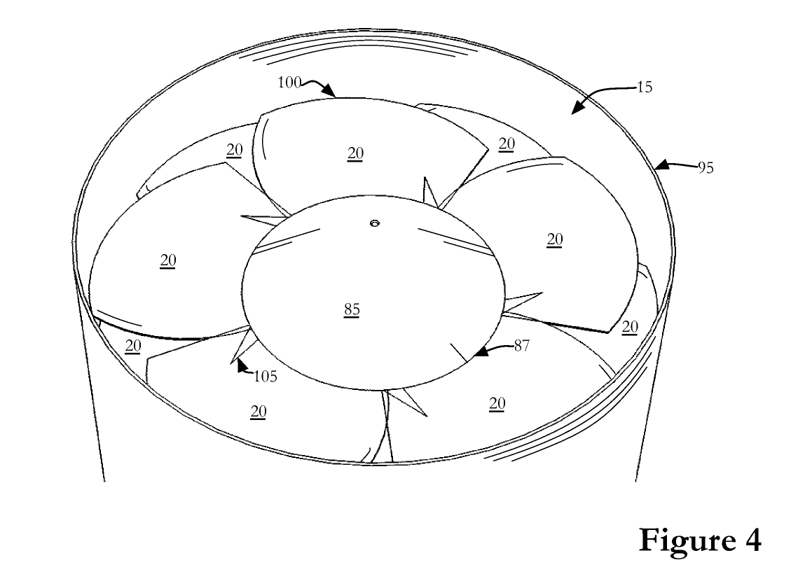

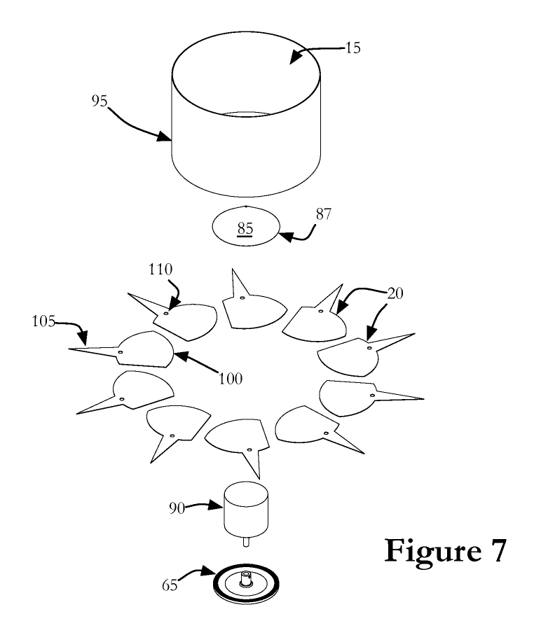

In order to explain this invention, this description presents two embodiments of the invention. The slotted disk shutter embodiment is depicted in FIGS. 1-3. The solid leaf shutter embodiment is depicted in FIGS. 4-7. Both embodiments use two or more shutters 20 to form a plurality of vertical through-passages 30. In one orientation, the shutters 20 are positioned to allow seed to descend vertically through the vertical through-passages 30. The shutters 20 can also be rotated horizontally to close off the vertical through passages 30, to prevent seed from descending.

The regulator uses two or more shutters 20 to control the volume and shape of the seed flow as the seed flow passes the atomizer. The shutters can be positioned in a closed orientation where the shutters are aligned to prevent any seed flow through the treatment chamber. The shutters can be rotated—horizontally—to an open orientation. In the open orientation, the shutters are positioned to form vertical through-passages that allow the seed to flow into the treatment chamber.

FIG. 1-3 depicts an example of the slotted disk shutter regulator with a top shutter 50 and a bottom shutter 55. Both shutters are disk shaped. An adjustable shaft 60 is connected to the regulator to control the relative orientation between the top shutter 50 and the bottom shutter 55.

In this example, the shutters have multiple apertures 25. The apertures 25 are slots that extend from the top of the shutter to the bottom. The pattern of the apertures 25 are arranged to align with certain apertures in other shutters to form the vertical through-passages. When the apertures 25 are aligned, they form a vertical through-passage 30.

The pattern of the apertures 25 allows the regulator to control the flow rate and the dispersion pattern of the seed. In a closed orientation, the apertures 25 do not overlap. This alignment prevents seed flow. The adjustable shaft 60 controls the relative orientation of the shutters 20. When a portion of the apertures 25 overlap that is at least as wide as the size of the seed, the seed can fall through the aligned apertures. When the apertures 25 are aligned, they define a plurality of vertical through-passages 30. The seed descends through the vertical through-passages 40 and enters the treatment chamber.

The number, size, shape and pattern of the vertical through-passages 30 determine the flow rate and dispersion pattern of the vertical seed flow into the treatment chamber. When the apertures 25 in the top disk 50 align completely with the apertures 25 in the bottom disk 55, the seed flows into the treatment chamber at the maximum rate.

In existing seed treatment systems, the metered seed flows onto a dispersion cones and enters the treatment chamber in the shape of an annular veil. At high flow rates, the width of the annular veil expands. The single, central fluid atomizer fluid can only apply the fluid treatment to the interior perimeter of the annular veil. The current inventors determined that the placement of the apertures 25 can increase seed surface area exposed to airborne treatment fluid. The illustrated embodiment in FIGS. 1-3 doubles the seed surface area exposed to airborne treatment fluid.

The atomizer 65—located below the regulator 10, and driven by atomizer motor 90—delivers an airborne fluid treatment to coat the exposed surface area of the seed as it descends through the treatment chamber. The shape of the dispersion pattern determines the amount of surface area of the seed flow that makes contact with the treatment fluid. This dispersion pattern—or treatment face—is defined by the vertical through-passages 30 in the regulator 10.

The seed is disbursed in a pattern of flow such that a greater “treatment face” or seed surface area is exposed to the airborne treatment fluid. The number, size, shape, and pattern of the vertical through-passages 30 are defined by the configuration of the apertures 25 in the shutters 20 as well as the relative orientation of the shutters 20.

Alternatively, FIGS. 4-7 depicts the regulator with a plurality of shutters 20 that are solid. The shutters 20 can also pivot horizontally, into and out of the seed flow path. The seed flow path is the annular aperture between the exterior housing 95 and the outer perimeter of the distribution cone 85. The shutters 20 control the flow rate and dispersion pattern by rotating into and out of the seed flow path.

The current example uses shutters with a large end 100 and a small end 105. In the closed configuration—depicted in FIG. 4—the large end 100 extends into the seed flow path to prohibit the seed flow. In this embodiment, the shutters pivot around a pivot point 110—which is located between the small end 105 and the large end 100 of each shutter.

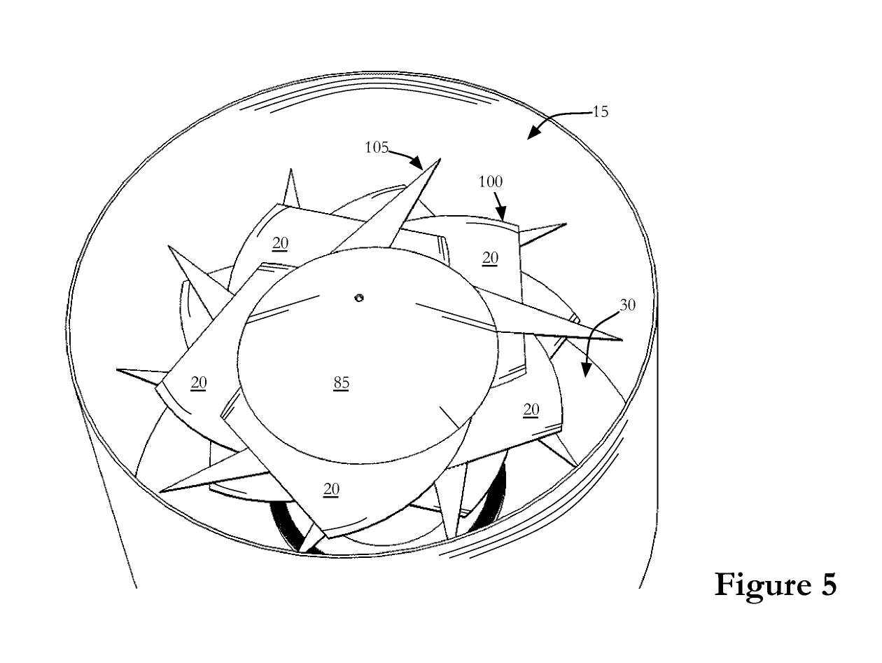

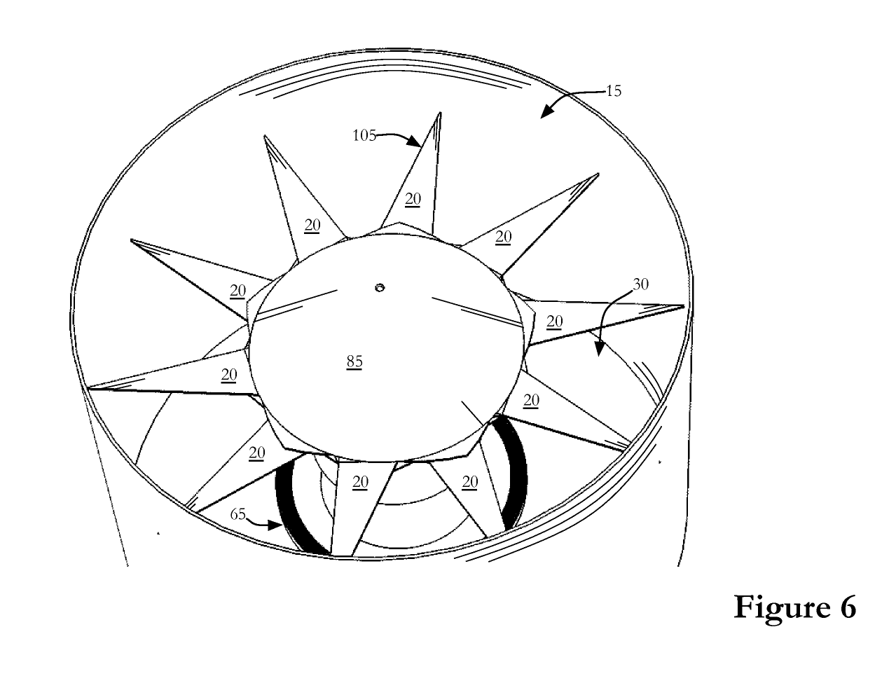

The regulator 10 allows seed to descend into the treatment chamber by rotating the shutters 20 about the pivot point 110. In the open configuration—depicted in FIG. 6—the small end 105 extends into the seed flow path. FIG. 5 depicts the shutters in between the closed configuration and the open configuration.

The regulator 10 controls the seed flow rate and dispersion pattern by rotating the individual shutters 20. Even in the open orientation, a portion of the small end 105 of the shutter 20 extends into the annular aperture 15. In the partially open orientation—of FIG. 5—portions of both the large end 100 and the small end 105 extend into the annular aperture 15. The vertical through-passage 30 is defined by the space between the shutters 20. As the shutters 20 rotate from the closed position to the open position, the flow rate of seed into the treatment chamber increases. The illustrated embodiment in FIGS. 4-7 can double the seed surface area exposed to airborne treatment fluid relative.

Another advantage of our regulator is the ability to control the flow rate and dispersion pattern in a single mechanism. Current seed treatment applicators have separate mechanisms for regulating seed flow and dispersion pattern. U.S. Pat. No. 5,891,246 to Lund, describes a conical, rotating seed dispersing member that disperses an even curtain of seed and a rotating fluid dispensing member for dispensing seed treatment composition. U.S. patent application Ser. No. 12/848,412 by Reineccius, describes an apparatus and method for introducing seed into the treatment chamber through the use of a volumetric seed wheel. A fixed dispersion cone then uniformly disperses the seed.

These existing seed treatment applicators have limited control of seed distribution in the treatment chamber. The inventors discovered a regulator 10 capable of continuously adjusting the dispersion pattern based on a variable flow rate—thereby optimizing the surface area exposed to treatment fluids under high and low flow rates.

While the illustrations and explanations in this disclosure refer to regulating the flow rate and dispersion pattern of seed, the disclosed technology could effectively regulate the flow rate and dispersion pattern of any flowing particulate matter. The number, size, shape, and pattern of the vertical through-passages 30 define the flow rate and dispersion pattern of the seed. The number, size, shape, and pattern can be optimized depending on the flow rate and dispersion pattern required in the specific application. For seed treatment applicators, a rotating disk atomizer 65 applies the fluid seed treatment as the seed descends through the treatment chamber. The treatment fluid is dispersed through the air in an even circular pattern from a singular, central source. In another application, the treatment fluid could be introduced from multiple sources along the exterior. By modifying the configuration of the vertical through-passages 30, the technology of the current disclosure could be effective in optimizing flow control and dispersion pattern.

Even distribution and variable flow are important in transferring granular material such as seed from a storage location to another processing point. For use in a seed treatment system, our regulator allows for a controlled and uniform flow of seed that increases surface area exposed to fluid treatment solutions applied by any combination of spray valves or rotating disk atomizers. By varying the number, size, shape, and pattern of the vertical through-passages, the regulator can maximize the amount of surface exposed to the airborne treatment fluid relative to the volume of seed flow.

In the embodiment depicted in FIGS. 1-3, the apertures 25 in the bottom disk 55 can be slanted to impart horizontal rotating motion to the vertical flow of the seed. This horizontal rotating motion can expose a greater seed surface area to the airborne treatment fluid. It is also possible to bevel the edge of the slots 20. A beveled edge, especially a beveling top of the aperture 25 of the bottom disk 55 will prevent damage to the seed when the disks are rotated to the closed position.

The adjustable shaft 60 can be attached to the top shutter 50, and the bottom shutter 55 can be fixed. It is also possible that the adjustable shaft 60 can be attached to the bottom shutter 55, and the top shutter 50 is fixed. It is also possible to have more than one or more adjustable shafts that control the rotation multiple shutters. The adjustable shaft 60 can be an actuator, such as the hydraulic or pneumatic actuator depicted in FIGS. 1-3. Alternatively, the adjustable shaft 60 could be driven by a rotary gear or other mechanism known to one skilled in the art. For the multiple solid shutter example depicted in FIGS. 4-7, the shutters 20 can be rotated by a single adjustable shaft that is interconnected to cause the individual shutters to rotate about the pivot point 110. Alternatively, groups of two or more shutters can be controlled by a independent adjustable shafts. It is also possible that each individual shutter is individually controlled by a dedicated adjustable shaft.

What is claimed is:

1. A device for regulating the flow rate and dispersion of a particulate matter comprising:
a. an annular aperture that receives a vertical flow of the particulate matter;
b. a regulator that has:
i. a plurality of shutters that are capable of rotating about a vertical axis;
ii. an adjustable shaft connected to the regulator to control the rotation of the shutters between:
1. a closed orientation, whereby the shutters are positioned within the annular aperture to prevent the particulate matter from descending through the regulator; and
2. an open orientation, whereby the shutters are positioned within the annular aperture to provide a vertical through-passage, thereby allowing at least a portion of the particulate matter to descend—under the force of gravity—through the regulator; and
c. a treatment applicator—located below the regulator—that delivers airborne fluid to the exposed surface area of the particulate matter as it descends in a flow pattern defined by the vertical through-passage in the regulator.

2. The device of claim 1, wherein the flow pattern is evenly distributed about the central vertical axis of the regulator and increases the surface area exposed to the airborne fluid relative to the material flowing as an annular veil.

3. The device of claim 2, further comprising an adjustable shaft to control the relative rotatory position of the shutters.

4. The device of claim 3, wherein each shutter is formed with a pattern of apertures arranged in such a way as to align with certain apertures in other shutters—in the second orientation—to form the plurality of vertical through-passage.

5. The device of claim 3, wherein the plurality of shutters are solid and the plurality of vertical through-passages are defined by the space between the relative rotary positions of the individual shutters.

6. The device of claim 5, wherein each shutter has a larger end that extends into the annular aperture and prohibits the flow of the particulate matter and a smaller end that extends into the annular aperture and allows seed to descend into the annular aperture according to a pre-determined dispersion pattern.

7. A regulator for controlling the flow rate and dispersion pattern of a particulate matter flowing under the force of gravity comprising:
a. an annular aperture that receives a vertical flow of the particulate matter; and
b. a plurality of shutters that rotate in a horizontal plane from a closed Orientation—wherein the shutters are positioned in alignment to prevent the flow of particulate matter—to an open orientation—wherein the shutters are positioned in alignment to form a plurality of vertical through-passages thereby allowing the particulate matter to descend through the annular aperture.

8. The regulator of claim 7 further comprising a treatment applicator—located below the regulator—that delivers an airborne fluid to the exposed surface area of the particulate matter as it descends in a dispersion pattern defined by the vertical through-passages in the regulator.

9. The regulator of claim 8, wherein the dispersion pattern is evenly distributed about the central vertical axis of the regulator and increases the surface area exposed to the airborne fluid relative to the material flowing as an annular veil.

10. The regulator of claim 9, wherein each shutter is formed with a pattern of apertures arranged in such a way as to align with certain apertures in other shutters—in the open orientation—to form the plurality of vertical through-passage.

11. The regulator of claim 10, wherein the regulator comprises:
a. a top shutter in the shape of a disk with a plurality of apertures that extend vertically through the top disk;
b. a bottom shutter in the shape of a disk with a plurality of apertures that extend vertically through the bottom disk; and
c. an adjustable shaft that is connected to the regulator to control the relative orientation of the top shutter and the bottom shutter.

12. The regulator of claim 9, wherein each shutter is solid and the plurality of vertical through-passages are defined by the space between the individual shutters.

13. The regulator of claim 12, further comprising a treatment applicator—located below the regulator—that delivers an airborne fluid treatment to coat the exposed surface area of the particulate matter as it descends in a dispersion pattern defined by the passageway in the regulator.

14. The regulator of claim 13, wherein the pattern of the vertical through-passages defines a dispersion pattern of the vertical flow of particulate matter that increases the surface area exposed to the airborne fluid treatment relative to the material flowing as an annular veil.

15. The regulator of claim 14, wherein each shutter has a larger end that extends into the annular aperture and prohibits the flow of the particulate matter and a smaller end that extends into the annular aperture and allows seed to descend into the annular aperture according to a pre-determined dispersion pattern.

16. The regulator of claim 15, further comprising an adjustable shaft to control the rotatory position of each shutter.

17. The regulator of claim 9, wherein the plurality of vertical through-passages are defined by the space between the individual shutters and a pattern of apertures in the individual shutters that arranged in such a way as to align with certain apertures in other shutters when the regulator is in the open orientation.

18. The regulator of claim 17, further comprising a treatment applicator—located below the regulator—that delivers an airborne fluid treatment to coat the exposed surface area of the particulate matter as it descends in a dispersion pattern defined by the passageway in the regulator.
